(19) United States
(12) Patent Application Publication
(10) Pub. No.: US 2006/0078049 A1
(43) Pub. Date: Apr. 13, 2006

(54) Method and system for entropy coding/decoding of a video bit stream for fine granularity scalability

(75) Inventors: Yiliang Bao, Irving, TX (US); Marta Karczewicz, Irving, TX (US); Justin Ridge, Irving, TX (US); Xianglin Wang, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/964,402

(22) Filed: Oct. 13, 2004

(51) Int. Cl. H04N 11/04; H04N 7/12; H04B 1/66; H04N 11/02

(52) U.S. Cl. 375/240.11; 375/240.18; 375/240.08; 375/240.24; 375/240.2; 375/240.03

(57) ABSTRACT

A method, program product and device for encoding and/or decoding video data can include treating coefficients in the enhancement layer corresponding to a non-zero coefficient in the base layer differently than a coefficient in the enhancement layer corresponding to a zero coefficient in the base layer. The sign of the base layer quantized coefficient can also be used as it indicates how the reconstructed error differs from the original signal. The coefficient of independent spatial transforms can be arranged into subbands and the encoding of the subbands can utilize spatial information and coded block flags and end of block flags to reduce bit rate. Rather than feeding the coefficients into a context-based adaptive binary arithmetic coding engine on a block-by-block basis, the subbands can be passed into the engine. Subband coefficients may be removed in a controlled manner, leading to a reduced bit-rate.

### BACKGROUND OF THE INVENTION

A. Field of the Invention

The present invention is directed to the field of video coding and, more specifically, to scalable video coding.

B. Background

Conventional video coding standards (e.g. MPEG-1 , H.261/263/264) involve encoding a video sequence according to a particular bit rate target. Once encoded, the standards do not provide a mechanism for transmitting or decoding the video sequence at a different bit rate setting to the one used for encoding. Consequently, when a lower bit rate version is required, computational effort must be devoted to (at least partially) decoding and re-encoding the video sequence.

In contrast, with scalable video coding, the video sequence is encoded in a manner such that an encoded sequence characterized by a lower bit rate can be produced simply through manipulation of the bit stream; in particular through selective removal of bits from the bit stream. Fine granularity scalability (FGS) is a type of scalability that can allow the bit rate of the video stream to be adjusted more or less arbitrarily within certain limits. The MPEG-21 SVC standard requires that the bit rate be adjustable in steps of 10%.

One strategy for generating such a video stream is to encode each video frame (either the original video signal or a transformed version of it) using a temporal decomposition scheme (e.g. wavelet transform in the temporal domain) into an embedded bit stream. Since the bit stream of each frame can be truncated in small steps, the possibility of controlling the bit rate of the entire video sequence is almost unlimited.

Expanding on this strategy, different methods exist for obtaining such an embedded bit stream. One method involves coding a base layer and enhancement layers during the same process and using essentially the same algorithms. Because the layers are encoded during the same process, this approach can facilitate exploitation of inter-layer dependency, e.g. dependencies between the base and enhancement layer.

A second approach involves independently encoding the video into a base layer bit stream, then generating a scalable enhancement layer separately. In this strategy, fine granularity scalability can be achieved mainly in the enhancement layer. Since the base layer and enhancement layers are encoded independently, it can be more challenging to exploit any inter-layer dependencies, and this may decrease coding efficiency. However, since production of a non-scalable base layer bit stream has been standardized, for many applications it is desirable to build a FGS system on top of a successful standard.

Both of the approaches described achieve quality scalability by producing a bit stream consisting of first a “base layer”, and secondly one or more “enhancement layers” that progressively refine the quality of the next-lower layer towards the original signal. A partial enhancement layer decoding is typically not possible without the quality of the decoded video decreasing significantly. This can be countered by adding FGS on top of the layered coder.

One exemplary implementation of combining FGS with such a layered approach involves the following key steps:
Encoding a base layer using a non-embedded video coding standard such as H.264;
Obtaining a reconstructed version of the encoded base layer;
Subtracting the reconstructed base layer from the original signal;
Performing a discrete cosign transform (DCT) on the 4×4 blocks of the differential frame. (See FIG. 2);
Separating the DCT coefficients into subbands according to their frequencies. (See. FIG. 3);
Encoding one or more bit planes in each layer, where each bit plane involves categorizing coefficients and encoding each in one of three passes:
   1. Known as the “significance propagation pass”, this pass identifies those coefficients that had reconstructed values of zero in the previous bit plane, and which had one or more neighboring coefficients with a non-zero reconstructed value in the previous bit plane. An encoded binary digit serves as a “significance bit” indicating whether the coefficient transitions from zero to non-zero in the current bit plane.
   2. Known as the “refinement pass”, this pass identifies those coefficients that had reconstructed non-zero values in the previous bit plane. An encoded binary digit refines the precision of these coefficients in the current bit plane.
   3. Known as the “remainder pass”, this pass encodes the remaining coefficients (i.e. those not already identified in the first or second passes). A “significance bit” is encoded for each coefficient, just as in the “significance propagation pass”, however the transition from zero to non-zero is statistically less likely in the absence of neighboring non-zero values, and thus the significance bit for this category of non-zero coefficients is encoded separately.

There are several problems with this approach. One problem is that base layer information is practically ignored, except in generating the differential frame. Another problem is that the performance of this FGS coder is generally unsatisfactory. One reason for the lack of efficiency is that the coding process produces an excess amount of zero symbols that consume a significant number of bits. While the arithmetic coder may maintain some probability distribution model for each coding context, it does not code the symbols efficiently if their distribution is extremely biased and the arithmetic coder cannot model the probability accurately. For example, assume that the symbol set to be encoded contains 0 and 1, each with a certain probability. If the probability of either symbol is larger than the maximum probability that can be maintained in the arithmetic coder, it is difficult to achieve good coding efficiency.

As such, there is a need for an improved FGS coder that can decrease redundancy between the base layer and enhancement layers. There is also a need for a compact FGS coding scheme that can be accurately modeled and thus efficiently encoded by an arithmetic encoder.

### SUMMARY OF THE INVENTION

Embodiments of the present invention disclose methods, computer code products, and devices for encoding video data comprising calculating transform coefficients for base layer blocks of video data, calculating transform coefficients for enhancement layer blocks of video data, arranging the transform coefficients from multiple enhancement layer blocks into subbands, and encoding subband coefficients into a bit stream. Arranging the coefficients into subbands can further include arranging coefficients of independent spatial transforms into subbands. Encoding subband coefficients into a bit stream can further comprise coding of a “coded flag” into a bit stream, said coded flag indicating whether any coefficients in a subband have non-zero values. Encoding a “coded flag” into a bit stream for a subband can further comprise dividing a subband into contiguous regions and encoding into a bit stream a coded block flag for each of said regions.

The methods, computer code products, and devices can further include feeding the coefficients arranged into subbands into a context-based adaptive binary arithmetic coding engine. In one embodiment, the subbands can be arranged so that subband coefficients may be removed in a controlled manner to reduce bit rate. In another embodiment, the context used for encoding an enhancement subband coefficient into a bit stream can be determined in part by the sign (positive, negative or zero) of a quantized base layer coefficient. In still another embodiment, the context used for encoding a subband coefficient into a bit stream can be determined in part by the values of coefficients that neighbored the subband coefficient prior to arrangement into subbands.

The methods, computer code products, and devices can further include the encoding of enhancement layer coefficient values into a bit stream using a “cyclical block” approach. In one embodiment, this is accomplished by encoding into a bit stream all coefficient values from a given block according to some scan order until a first non-zero coefficient value is encountered, then moving to a neighboring block and repeating the process until one non-zero coefficient from each block has been encoded, then returning to the first block for another coding “cycle”, wherein coding of coefficients according to the scan order is resumed and continues until a second non-zero value is encountered. The process proceeds in this cyclical fashion until all coefficients in all blocks have been coded. In another embodiment, an end of block flag precedes the coefficients from each block in each cycle, i.e. for each block, an end of block flag can be encoded immediately followed by the coefficient values as described above. An end of block marker indicates whether the last encoded non-zero coefficient from a given block was the last non-zero value in that given block, except for the first cycle where it serves as a coded block flag, indicating whether there are any non-zero values in the block at all.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 is a block diagramming illustrating one embodiment of a communications device according to the present invention;

FIG. 2 is an illustration of 4×4 blocks of a differential frame;

FIG. 3 is an illustration of DCT coefficients separated into subbands according to their frequencies;

FIG. 4 is an illustration of a base layer quantization process.

FIG. 5 is an illustration of the dynamic range of the error signal for a positive coefficient in the base layer.

FIG. 6 is an illustration of the dynamic range of the error signal for a negative coefficient in the base layer.

FIG. 7 is an illustration of the dynamic range of the error signal for a zero coefficient in the base layer.

FIG. 8 is an illustration of a zigzag scanning order.

FIG. 9 is an illustration of an end

FIG. 10 is an illustration of and embedded end of block flag according to one embodiment of the present invention.

### DETAILED DESCRIPTION OF EXEMPLARY EMBODIMENTS

Embodiments of the invention present methods, computer code products, and devices for efficient FGS encoding and decoding. Embodiments of the present invention can be used to solve some of the problems inherent to existing solutions. For example, one issue previously mentioned is how to minimize the redundancy existing between the base layer and an FGS enhancement layer.

In this section, the term “enhancement layer” refers to a layer that is coded differentially compared to some lower quality reconstruction. The purpose of the enhancement layer is that, when added to the lower quality reconstruction, signal quality should improve, or be “enhanced”. In this section, the term “base layer” applies to both a non-scalable base layer encoded using an existing video coding algorithm, and to a reconstructed enhancement layer relative to which a subsequent enhancement layer is coded.

As mentioned above, the base layer could be encoded as a non-scalable stream with some existing coding technology such as H.264. H.264 decodes the coefficients in a hierarchy. A frame of video data can be partitioned into macro blocks (MB). A MB can consists of a 16×16 block of luminance values, an 8×8 block of chrominance-Cb values, and an 8×8 block of chrominance-Cr values. An MB skipping flag can be set in this level if all the information of this macro block can be inferred from the information that is already decoded, by using pre-defined rules.

If the macro block is not skipped, a Coded Block Pattern (CBP) can be decoded from the bit stream to indicate the distribution of the non-zero coefficients in the macro block. After a CBP is decoded, a coded block flag can be decoded from the bit stream in the next level for either 4×4 blocks or 2×2 blocks (depending on the coefficient type) to indicate whether there are any non-zero coefficients in the block. If there are any non-zero coefficients in a block of size 4×4, or of size 2×2 for chroma DC coefficients, the positions, as well as the values, of those non-zero coefficients can be decoded, and the value of each coefficient in a block can be determined using a predefined scanning order.

In H.264 base layer coding, the transform scheme can depend on the prediction mode. For example, if the prediction mode for luma is intra 16×16, a 4×4 transform can be performed on each block in the spatial domain, and additional 4×4 DC transform can be performed on the DC coefficients of the 16 4×4 blocks in a macroblock. For other prediction modes, it may not be necessary to perform an additional DC transform. The same transform could be applied in order to establish better correlation between the enhancement layer and base layer.

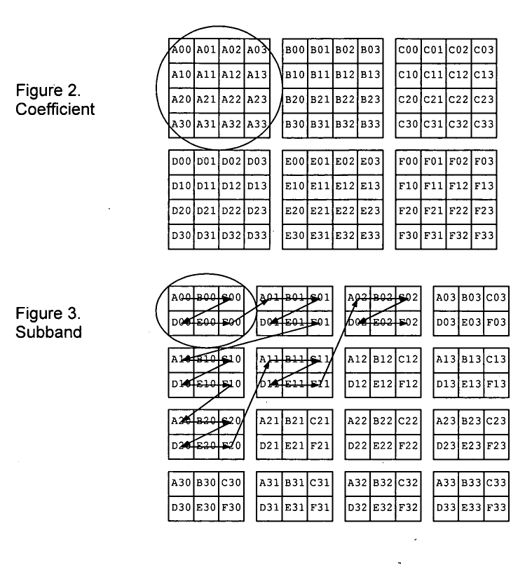

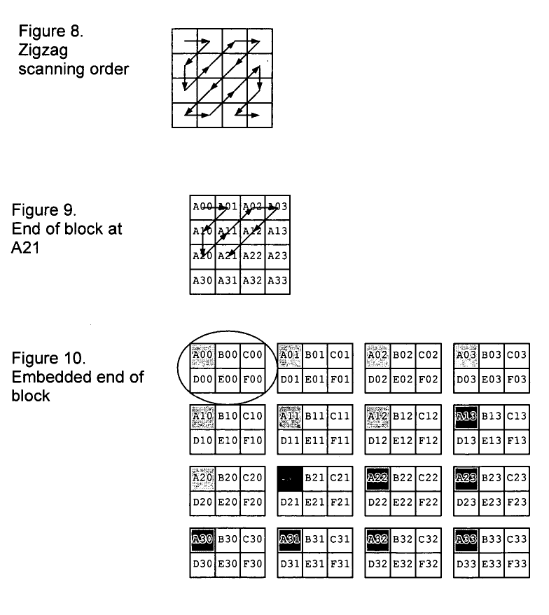

One aspect of this invention is that information from the base layer can be better utilized when encoding enhancement layer information, when compared to existing FGS schemes. In one embodiment of the invention, the coded block flag bit can be defined for a coefficient block (as defined in FIG. 2) in the enhancement layer to indicate whether this block has some coefficients that become significant in a given bitplane. As described above, the original definition of the coded block flag can indicate whether there are any nonzero coefficients in the block. In this embodiment, the definition can be adapted to coding of the enhancement layer, so that the coded block flag indicates whether the enhancement layer block contains any new significant coefficients. In addition, the end of block (EOB) flag for a coefficient block (as defined in FIG. 2) can be defined so that there are no more new significant coefficients in the same block following a zigzag order. In this embodiment, the definition of the EOB flag can also be adapted to the enhancement layer coding (see FIGS. 8, 9, and 10).

In applying the coded block flag and EOB flag to enhancement layer encoding, some modifications can be made. For example, in enhancement layer coding, the signal will be progressively refined, so some coefficients that were zero in the base layer can become non-zero in the enhancement layer. In one embodiment, the coded block pattern and EOB can be used only for encoding those coefficients that were zero in the base layer into a bit stream. In other words, they can be used only for coding the coefficients that become significant only in the current layer. A more detailed description of entropy coding for scalable video is presented in U.S. patent application Ser. Nos. 10/887,771 and 10/891,271, filed on Jul. 9, 2004 and Jul. 14, 2004, respectively, both of which are incorporated herein in their entirety by reference. In the remainder of this invention, the terms “coefficient” and “significance bit” can be used interchangeably with respect to the enhancement layer.

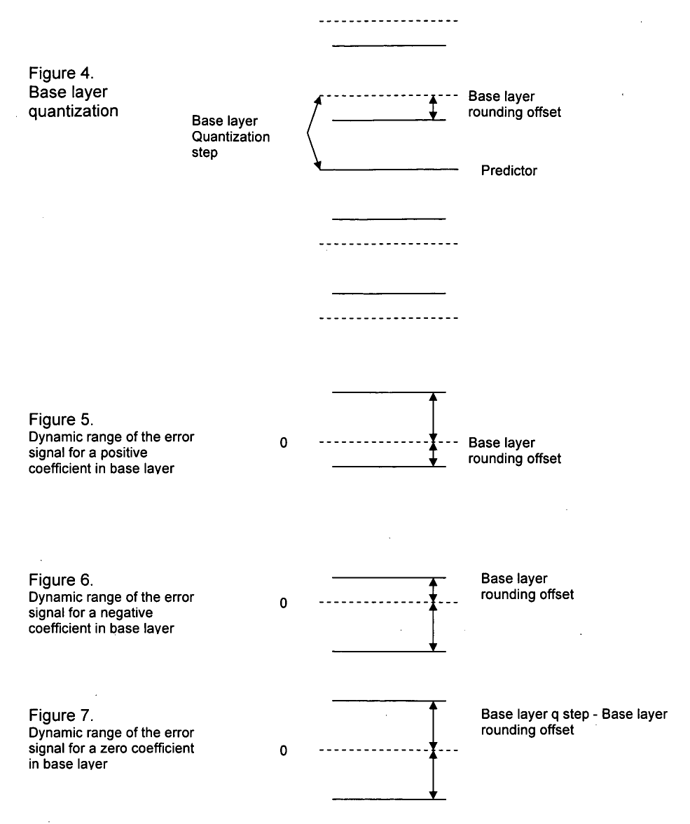

A further aspect of this invention involves taking the quantized base layer value into consideration when choosing a context for coefficient encoding. FIG. 4 shows one embodiment of a quantization process. In this process, quantization of the coefficient can be performed using a division operation with a certain rounding offset. FIGS. 5, 6, and 7 provide an explanation of how the reconstructed signal can differ from the original signal depending on whether the quantized coefficient is positive, negative and zero.

In one embodiment of the invention, information about the quantized coefficients of the base layer can be used for decoding the enhancement layer. This can be applicable whether the enhancement layer coefficients are arranged in blocks, or have been rearranged into subbands. Specifically, the quantization error (i.e. the difference between the reconstructed and unquantized coefficient values) can differ depending on whether the coefficient was quantized to a value of zero or non-zero in the base layer. Multiple sets of contexts can be defined for each of the significance information and the sign information, with the appropriate context being selected based upon the zero/non-zero status of the quantized coefficient in the base layer.

In this sense, “context” can refer to an adaptive binary arithmetic coding context. A context-based adaptive binary arithmetic coding engine can comprise two parts, context modeling and a binary arithmetic coding engine. The binary arithmetic coding engine usually decodes a symbol based on the current probability estimate of the symbol. The probability of a symbol can be estimated within a certain context in order to achieve good compression ratio. The context modeling in a compression system can be used to define various coding contexts in order to achieve the best possible compression performance.

Another aspect of the invention can be to provide a coding scheme designed so that the description of the enhancement layer is very compact and can be accurately modeled, hence promoting efficient encoding by the arithmetic coder. In bitplane coding, usually a significant amount of bits are spent on encoding the zeros. It can become very beneficial to define other syntax elements so that the number of zeros coded is reduced, thereby improving overall performance despite the extra overhead of coding those syntax elements.

In the base layer coding, it is common to use two syntax elements to reduce the number of zeros to be encoded: 1) a coded block flag, and 2) an end of block (EOB) flag. The coded block flag, which can be defined for blocks of different sizes, can be used to tell whether a block contains all zero coefficients or some non-zero coefficients. If there are some non-zero coefficients in the block, the individual coefficients can be checked. The EOB flag can be used in this case to tell, in a certain scanning order, that a non-zero coefficient at certain position will be the last non-zero coefficient encountered. This can be used to signal that it is not necessary to encode the following zeros.

While this approach is conceptually sound, a problem occurs if the syntax elements appear too early in the coding process. For example, if a coded block flag is sent at the start of each block, a considerable number of bits may be required before any coefficients can be decoded. Consequently, while overall coding efficiency may improve, it is possible that coding efficiency will suffer if only part of the FGS layer is decoded.

This can be overcome by deferring insertion of syntax elements into the bit stream until they become relevant. This invention further describes how this may be achieved with respect to the end of block (EOB) marker, in the case where coefficients remain structured as blocks and not in subbands.

According to this aspect of the invention, in one embodiment precisely one non-zero coefficient value from each block containing uncoded non-zero coefficient values is encoded into the bit stream. The process can be repeated in a cyclical fashion until all non-zero coefficient values have been encoded.

In one embodiment, a block scanning pattern (such as a zigzag scan) can be established. Starting with the first block, coefficients can be encoded into the bit stream one by one until the first non-zero coefficient has been encoded. The process can then be repeated for a second block, then a third block, and so on until one non-zero coefficient has been encoded from each block. Moving back to the first block, the cycle can be repeated, with encoding commencing with the coefficient immediately after the last encoded coefficient according to the scanning pattern.

To avoid encoding large numbers of zero-valued coefficients, a coded block flag can be encoded into the bit stream for each block during the first cycle. In this first cycle, for each block the coded block flag can be encoded into the bit stream, followed by the zero-valued coefficients and the first non-zero coefficient as described above. The process can then be repeated for other blocks until the first cycle is complete. In the second and subsequent cycles, an EOB marker can be encoded into the bit stream for each block that may still contain non-zero values (i.e. a coded block flag indicated that the block contains non-zero values, but an EOB marker has not been encoded in previous cycles). For each such block, an EOB marker can be encoded into the bit stream, the value of said EOB marker indicating whether the non-zero valued coefficient from this block encoded in the previous cycle was the last non-zero coefficient in the block. If so, no further coefficients from the block need be encoded in this or subsequent cycles. If not, encoding of coefficients for the block can proceed until the next non-zero coefficient value is encountered, as described above. The process can then be repeated for other blocks until the cycle is complete.

A further aspect of this invention is that the coded block flag and end of block marker, along with the associated enhancements to coding thereof identified previously, may continue to be utilized after coefficients are rearranged into subbands.

FIGS. 9 and 10 illustrate how the EOB flag can be embedded in a symbol stream that is coded by subband. In this example, if coefficient A21 in 4×4 block A is the last non-zero coefficient in the block and the coefficients are subsequently arranged into subbands, coefficients A13, A22, A23, A30, A31, A32, and A33 do not need to be encoded.

A further aspect of this invention is that the concepts of coded block flag and end of block marker that are known in the context of encoding blocks of coefficients as described above may also be applied to subbands. In one embodiment, after arranging enhancement layer coefficients into subbands, a “coded flag” can indicate whether an enhancement layer subband contains any non-zero coefficients that were zero in the base layer. In addition, the end of subband flag can be used to signal the end of an enhancement layer subband.

In a further embodiment of this invention, subbands can be subdivided into contiguous areas, such as rectangular blocks, and encoding into the bit stream a coded block flag indicating whether any of the subband coefficient values in that region are non-zero.

Another aspect of this invention is the improvement of context modeling through spatial contexts in subband coding. Context modeling may be improved by utilizing the values of neighboring coefficients (i.e. before arrangement into subbands) when encoding a given coefficient into a bit stream. In one embodiment, considering FIG. 3 as an example, the context of coefficient B30 may be influenced by coefficients A23, A33 and B20.

The invention can be implemented directly in software using any common programming language, e.g. C/C++ or assembly language. This invention can also be implemented in hardware and used in consumer devices.

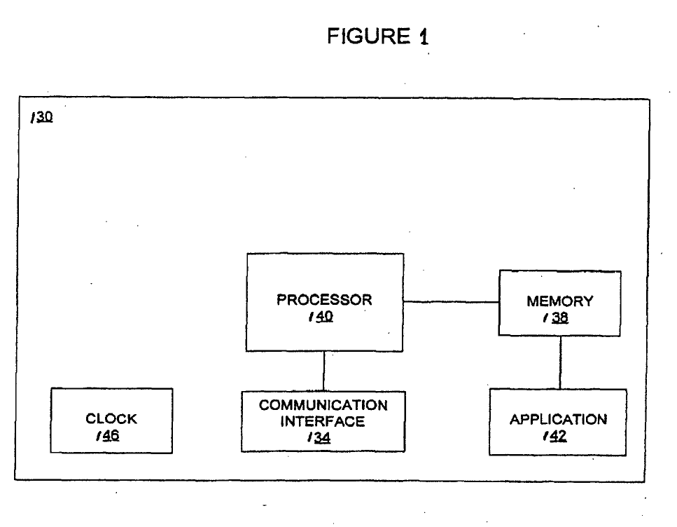

One possible implementation of the present invention is as part of a communication device (such as a mobile communication device like a cellular telephone, or a network device like a base station, router, repeater, etc.). A communication device 130, as shown in FIG. 1, comprises a communication interface 134, a memory 138, a processor 140, an application 142, and a clock 146. The exact architecture of communication device 130 is not important. Different and additional components of communication device 130 may be incorporated into the communication device 130. For example, if the device 130 is a cellular telephone it may also include a display screen, and one or more input interfaces such as a keyboard, a touch screen and a camera. The scalable video encoding techniques of the present invention could be performed in the processor 140 and memory 138 of the communication device 130.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps,.correlation steps, comparison steps and decision steps. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principals of the present invention and its practical application to enable one skilled in the art to utilize the present invention in various embodiments and with various modifications as are suited to the particular use contemplated.

What is claimed is:

1. A method of encoding video data into a bit stream, said method comprising:
calculating transform coefficients for base layer blocks of video data;
calculating transform coefficients for enhancement layer blocks of video data;
arranging the transform coefficients from multiple enhancement layer blocks into subbands; and
encoding into a bit stream a coded region flag for a region of enhancement layer coefficients, corresponding to a region of base layer coefficients, only if it is determined that the base layer region contains only zero-valued coefficients.

2. The method of claim 1 wherein the region of coefficients comprises coefficients belonging to a block prior to arranging the transform coefficients into subbands.

3. The method of claim 1 wherein the region of coefficients comprises all coefficients in a subband.

4. The method of claim 1 wherein an end of block flag is also encoded into a bit stream when the coded region flag is either not encoded or indicates the presence of non-zero values in a region.

5. The method of claim 4 wherein the region includes a beginning and end and a last coefficient at the end of the region such that the end of block flag is not encoded when the last coefficient in the region is non-zero.

6. The method according to claim 3, wherein subbands are subdivided into contiguous regions, and a coded block flag is encoded into the bit stream for each such region.

7. The method according to claim 6, wherein the contiguous regions are rectangular.

8. The method according to claim 1, further comprising feeding the coefficients arranged into subbands into a context-based adaptive binary arithmetic coding engine.

9. The method according to claim 1, wherein arranging the coefficients further comprises arranging coefficients of independent spatial transforms into subbands.

10. The method according to claim 9, wherein encoding of each subband utilizes spatial information.

11. The method according to claim 10, wherein utilization of spatial information involves selecting contexts for encoding a given coefficient value, and said contexts are selected based at least in part upon neighboring coefficient values according to some arrangement of block coefficients prior to arrangement into subbands.

12. The method according to claim 8, wherein context selection for the arithmetic coder includes the steps of:
ordering the coefficients spatially according to some prescribed pattern;
identifying coefficients neighboring a coefficient to be encoded;
selecting a context based at least in part upon values of said identified neighboring coefficients.

13. The method according to claim 12, wherein ordering the coefficients spatially involves ordering the coefficients originating from a given block in a two dimensional grid by frequency, with the lowest and highest frequencies diagonally opposite.

14. A method of encoding video data into a bit stream, said method comprising:
calculating transform coefficients for base layer blocks of video data;
calculating transform coefficients for multiple enhancement layer blocks of video data;
selecting coefficients to be encoded from each of the multiple enhancement layer blocks;
encoding the selected enhancement layer coefficients into a bit stream, one block at a time;
iterating said selecting and encoding operations until all non-zero coefficient values have been encoded.

15. The method according to claim 14, wherein selecting the enhancement layer coefficients to be encoded from a given block comprises:
ordering the coefficients of said block into a list according to a scanning pattern;
identifying a coefficient in said list that was last encoded;
selecting all coefficients starting with a coefficient immediately following said identified last coefficient in scan order, and ending with a first non-zero coefficient occurring after said identified last coefficient in scan order.

16. The method according to claim 15,.wherein the scan order is a zigzag pattern.

17. The method according to claim 14, wherein encoding the selected coefficients for a given block comprises:
determining whether a most recently coded coefficient from the block was the last non-zero value in the block according to a scan order;
encoding an end of block marker if said determination finds that the most recently coded coefficient is the last non-zero value in the block;
encoding selected coefficient values if said determination finds that the most recently coded coefficient is not the last non-zero value in the block.

18. A method of encoding video data into a bit stream, said method comprising:
calculating transform coefficients for a base layer of video data;
calculating transform coefficients for an enhancement layer of video data;
encoding the transform coefficients for said enhancement layer into a bit stream using a context-based arithmetic coder.

19. The method according to claim 18, wherein context selection for the arithmetic coder depends at least in part upon whether a quantized value of a base layer coefficient corresponding to an enhancement layer coefficient was zero or non-zero.

20. The method according to claim 18, further comprising calculating a quantized value of the base layer coefficients and a sign of the base layer quantized coefficients, wherein context selection for the arithmetic coder depends at least in part upon the sign of the base layer quantized coefficient.

21. The method according to claim 18, wherein:
encoding of coefficients is done one bit plane at a time, each bit plane being divided into at least one region;
a coded region flag is encoded for each region in the bit plane to indicate whether the region includes any new significant coefficients;
an end of region flag is encoded for each region in the bit plane when all new significant coefficients in the region according to some scan order have been encoded.

22. The method according to claim 21, where a region is a contiguous block of coefficients.

23. The method according to claim 21, where a region is a subband of coefficients.

24. A computer code product for encoding video data, the computer code product comprising:
computer code containing machine readable program code for causing, when executed, one or more machines to perform the following:
calculating DCT coefficients for base layer blocks of video data;
calculating DCT coefficients for enhancement layer blocks of video data;
arranging the DCT coefficients from multiple enhancement layer blocks into subbands;
determining whether the base layer blocks include zero coefficients; and
encoding a coded block flag and end of block flag for an enhancement layer block of video data, corresponding to a base layer block, only if it is determined that the base layer block contains zero coefficients.

25. The computer code product according to claim 24, wherein arranging the coefficients into subbands further comprises arranging the coefficients into zones such that different zones can be encoded in parallel to achieve block-by-block coding.

26. The computer code product according to claim 25, wherein the zones are rectangle based.

27. The computer code product according to claim 25, wherein the zones are scanning based.

28. The computer code product of encoding according to claim 24, wherein the product code further causes feeding the coefficients arranged into subbands into a context-based adaptive binary arithmetic coding engine.

29. The computer code product of encoding according to claim 28, wherein the subbands are arranged so that subband coefficients may be removed in a controlled manner to reduce bit rate.

30. The computer code product of encoding of claim 24, wherein arranging the coefficients further comprises arranging coefficients of independent spatial transforms into subbands.

31. The computer code product of encoding of claims 30, wherein encoding of each subband utilizes spatial information.

32. A computer code product for encoding video data into a bit stream, said computer code product comprising:
computer code containing machine readable program code for causing, when executed, one or more machines to perform the following:
calculating transform coefficients for base layer blocks of video data;
calculating transform coefficients for multiple enhancement layer blocks of video data;
selecting coefficients to be encoded from each of the multiple enhancement layer blocks;
encoding the selected enhancement layer coefficients into a bit stream, one block at a time;
iterating said selecting and encoding operations until all non-zero coefficient values have been encoded.

33. The computer code product according to claim 32, wherein selecting the enhancement layer coefficients to be encoded from a given block comprises:
ordering the coefficients of said block into a list according to a scanning pattern;
identifying a coefficient in said list that was last encoded;
selecting all coefficients starting with a coefficient immediately following said identified last coefficient in scan order, and ending with a first non-zero coefficient occurring after said identified last coefficient in scan order.

34. The computer code product according to claim 33, wherein the scan order is a zigzag pattern.

35. The computer code product according to claim 32, wherein encoding the selected coefficients for a given block comprises:
determining whether a most recently coded coefficient from the block was the last non-zero value in the block according to a scan order;
encoding an end of block marker if said determination finds that the most recently coded coefficient is the last non-zero value in the block;
encoding selected coefficient values if said determination finds that the most recently coded coefficient is not the last non-zero value in the block.

36. A computer code product for encoding video data into a bit stream, said method comprising:
computer code containing machine readable program code forcasuing, when executed, one or more machines to perform the following:
calculating transform coefficients for a base layer of video data;
calculating transform coefficients for an enhancement layer of video data;
encoding the transform coefficients for said enhancement layer into a bit stream using a context-based arithmetic coder.

37. The method according to claim 36, wherein context selection for the arithmetic coder depends at least in part upon whether a quantized value of a base layer coefficient corresponding to an enhancement layer coefficient was zero or non-zero.

38. The method according to claim 36, further comprising calculating a quantized value of the base layer coefficients and a sign of the base layer quantized coefficients, wherein context selection for the arithmetic coder depends at least in part upon the sign of the base layer quantized coefficient.

39. The method according to claim 36, wherein:
encoding of coefficients is done one bit plane at a time, each bit plane being divided into at least one region;
a coded region flag is encoded for each region in the bit plane to indicate whether the region includes any new significant coefficients;
an end of region flag is encoded for each region in the bit plane when all new significant coefficients in the region according to some scan order have been encoded.

40. The method according to claim 39, where a region is a contiguous block of coefficients.

41. The method according to claim 39, where a region is a subband of coefficients.

42. A device for encoding for encoding video data, the device comprising:
a processor;
memory; and
an application for causing, when executed, one or more machines to perform the following:
calculating DCT coefficients for base layer macro blocks of video data;
calculating DCT coefficients for enhancement layer macro blocks of video data;
arranging the DCT coefficients from multiple enhancement layer macro blocks into subbands;
determining whether the base layer macro blocks include zero coefficients; and
encoding a coded block flag and end of block flag for an enhancement layer macro block of video data, corresponding to a base layer macro block, only if it is determined that the base layer macro block contains zero coefficients.

43. The device according to claim 42, wherein arranging the coefficients into subbands further comprises arranging the coefficients into zones such that different zones can be encoded in parallel to achieve block-by-block coding.

44. The device according to claim 43, wherein the zones are rectangle based.

45. The device according to claim 43, wherein the zones are scanning based.

46. The device according to claim 42, wherein the application further causes feeding the coefficients arranged into subbands into a context-based adaptive binary arithmetic coding engine.

47. The device according to claim 46, wherein the subbands are arranged so that subband coefficients may be removed in a controlled manner to reduce bit rate.

48. The device according to claim 46, wherein arranging the coefficients further comprises arranging coefficients of independent spatial transforms into subbands.

49. The device according to claim 48, wherein encoding of each subband utilizes spatial information.

50. A device for encoding video data into a bit stream, said device comprising:
a processor;
a memory; and
an application for causing, when executed, one or more machines to perform the following:
calculating transform coefficients for base layer blocks of video data;
calculating transform coefficients for multiple enhancement layer blocks of video data;
selecting coefficients to be encoded from each of the multiple enhancement layer blocks;
encoding the selected enhancement layer coefficients into a bit stream, one block at a time;
iterating said selecting and encoding operations until all non-zero coefficient values have been encoded.

51. The device according to claim 50, wherein selecting the enhancement layer coefficients to be encoded from a given block comprises:
ordering the coefficients of said block into a list according to a scanning pattern;
identifying a coefficient in said list that was last encoded;
selecting all coefficients starting with a coefficient immediately following said identified last coefficient in scan order, and ending with a first non-zero coefficient occurring after said identified last coefficient in scan order.

52. The device according to claim 51, wherein the scan order is a zigzag pattern.

53. The device according to claim 50, wherein encoding the selected coefficients for a given block comprises:
determining whether a most recently coded coefficient from the block was the last non-zero value in the block according to a scan order;
encoding an end of block marker if said determination finds that the most recently coded coefficient is the last non-zero value in the block;
encoding selected coefficient values if said determination finds that the most recently coded coefficient is not the last non-zero value in the block.

54. A device for encoding video data into a bit stream, said method comprising:
a processor;
a memory; and
an application for causing, when executed, one or more machines to perform the following:
calculating transform coefficients for a base layer of video data;
calculating transform coefficients for an enhancement layer of video data;
encoding the transform coefficients for said enhancement layer into a bit stream using a context-based arithmetic coder.

55. The device according to claim 54, wherein context selection for the arithmetic coder depends at least in part upon whether a quantized value of a base layer coefficient corresponding to an enhancement layer coefficient was zero or non-zero.

56. The device according to claim 54, further comprising calculating a quantized value of the base layer coefficients and a sign of the base layer quantized coefficients, wherein context selection for the arithmetic coder depends at least in part upon the sign of the base layer quantized coefficient.

57. The device according to claim 54, wherein:
encoding of coefficients is done one bit plane at a time, each bit plane being divided into at least one region;
a coded region flag is encoded for each region in the bit plane to indicate whether the region includes any new significant coefficients;
an end of region flag is encoded for each region in the bit plane when all new significant coefficients in the region according to some scan order have been encoded.

58. The device according to claim 57, where a region is a contiguous block of coefficients.

58. The device according to claim 57,,where a region is a subband of coefficients.

59. A method of decoding video data, the method comprising:
decoding transform coefficients for base layer block of video data;
decoding a coded region flag if a region of base layer coefficients contains only zero-valued coefficients;
decoding subband coefficients when their availability is indicated by the coded region flag or when a region of base layer coefficients contains at least one non-zero-valued coefficient; and
arranging the subband coefficients into multiple enhancement layer blocks.

60. The method of claim 59 wherein the region of base layer coefficients consists of those coefficients that will belong to a given block after arrangement of the transform coefficients into blocks in an encoding procedure.

61. The method of claim 59 wherein the region of base layer coefficients consists of all coefficients in a subband.

62. The method of claim 59 wherein an end of block flag is decoded when a coded region flag is either not decoded or when a decoded coded region flag indicates the presence of non-zero values in a block.

63. The method of claim 62 wherein the end of block flag is not decoded for a last coefficient in a block.

64. The method according to claim 61, wherein subbands are divided into contiguous regions, and a coded block flag is decoded for each such region.

65. The method according to claim 64, wherein the contiguous regions are rectangular.

66. The method according to claim 59, further comprising feeding the subband coefficients into a context-based adaptive binary arithmetic decoding engine.

67. The method according to claim 59, wherein arranging the coefficients into blocks further comprises arranging subband coefficients into blocks of independent spatial transforms.

68. The method according to claim 67, wherein decoding of each subband utilizes spatial information.

69. The method according to claim 68, wherein utilization of spatial information involves selecting contexts to be used when decoding a given coefficient, and said contexts are selected based at least in part upon previously decoded neighboring coefficient values according to some arrangement of coefficients following rearrangement into blocks.

70. The method according to claim 66 wherein context selection for the arithmetic coder includes the steps of:
ordering the coefficients spatially according to some prescribed pattern;
identifying coefficients neighboring the coefficient to be encoded;
selecting a context based at least in part upon the values of said identified neighboring coefficients.

71. The method according to claim 70, wherein ordering the coefficients spatially involves ordering the coefficients originating from a given block in a two dimensional grid by frequency, with the lowest and highest frequencies diagonally opposite.

72. A method of decoding video data comprising base layer blocks and enhancement layer blocks, said method comprising:
decoding transform coefficients for the base layer blocks of video data;
decoding one or more enhancement coefficients for each enhancement layer block;
assigning said decoded coefficients to coefficient positions within said enhancement layer blocks;
iterating said decoding and assigning operations until all coefficient values for said enhancement layer blocks have been decoded.

73. The method according to claim 72, wherein decoding one or more enhancement layer coefficients for each enhancement layer block comprises:
decoding an end of block symbol indicating if a last decoded coefficient from the enhancement layer block was the last non-zero coefficient in the block according to a scan order;
assigning zero to the remaining coefficient values in the block if said decoding indicates that the end of block has been reached;
decoding coefficient values from said enhancement layer block until a non-zero valued coefficient is decoded if an end of block has not been indicated;
iterating said decoding, assigning and decoding operations for each of a multiplicity of blocks.

74. The method according to claim 72, wherein assigning decoded coefficients to coefficient positions within a block comprises assigning decoded coefficients to sequential positions according to a scan order.

75. The method according to claim 74, wherein the scan order is a zigzag pattern.

76. A method of decoding video data, said method comprising:
decoding transform coefficients for base layer blocks of video data;
decoding transform coefficients for enhancement layer blocks from a bit stream using a context-based arithmetic decoder.

77. The method according to claim 76, wherein context selection for the arithmetic decoder depends at least in part upon whether a quantized value of a corresponding decoded base layer coefficient was zero or non-zero.

78. The method according to claim 76, wherein context selection for the arithmetic decoder depends at least in part upon a sign of a base layer quantized decoded coefficient.

79. The method according to claim 76, wherein:
decoding of enhancement layer coefficients is performed one bit plane at a time;
a coded block flag is decoded for each block in the bit plane to indicate whether the block includes any new significant coefficients;
an end of block flag is decoded for each block in the bit plane when all new significant coefficients in the block according to some scan order have been decoded.
